(19) United States
(12) Patent Application Publication
(10) Pub. No.: US 2012/0223825 A1
(43) Pub. Date: Sep. 6, 2012

(54) SILENT CAR ALARM

(76) Inventor: David DosSantos, Maua Sao Paulo (BR)

(21) Appl. No.: 13/039,399

(22) Filed: Mar. 3, 2011

(51) Int. Cl. B60R 25/10

(52) U.S. Cl. 340/426.21

(57) ABSTRACT

The Present Invention is pre-programmed cellular telephone device capable of placing calls over the cellular telephone network that is hidden somewhere in an automobile in order to prevent or discourage theft. The device auto dials any pre-programmed existing phone numbers. The triggering mechanism alerts the owner in a sequence of warnings. The first warning alerts that door handle is being compromised. The second warning is an alert that the car door has been opened. The third warning alerts that the ignition has started. The fourth warning alerts that the car is in motion. After the fourth warning, the auto dial system prompts the owner to alert the police. It need not emit any sound. It only transmits an instant message using a working cellular telephone.

### CROSS REFERENCE TO RELATED APPLICATIONS

This Present Application is the nonprovisional counterpart of U.S. Provisional Patent Application Ser. No. 61/247994 filed on Oct. 2, 2009. This Present Application claims the benefit of and priority to said US provisional application which is incorporated herein in its entirety.

### BACKGROUND OF THE INVENTION

Noise pollution in the United States affects million of Americans. Car alarms contribute to the problem. Automobile owners who install these systems into their vehicles rarely think about the effect they would have on their next-door neighbors. The most insignificant triggers, such as loud boom box stereos or moving objects that might hit or rub against the vehicles can activate vehicle alarm systems. Often, these alarms go off in the middle of the night, with loud noises that awaken everybody within range. These unavoidable consequences induce a tendency not to respond to them and an annoyance from neighbors. Vehicle owners must consider this, and take safety measures when leaving their cars parked for long periods, even in the safest neighborhoods. They must insure that car windows are completely sealed. They must walk around the vehicle to be certain that each door latch is secure. They cannot leave personal items in the vehicle such as portable stereos bags and wallets in places visible to pedestrians. Generally, vehicle forced entries are quick and easy. Vehicle steering wheel locks or tire wedges can be pried open or cut, even while an alarm is triggered, and if the owner does not take immediate action, the vehicle will be stolen. Car alarms usually emit sounds having high and low pitches in sequence. Most thieves are not scared off by this, and usually are successful in stealing the vehicle.

The Lo Jack® Stolen Vehicle Recovery System solves the issue of locating the vehicle with a device hidden in the vehicle that emits a signal that enables law enforcement to target by triangulation. Police can track the emitted signal and locate the car. Once the owner discovers that his or her car is missing, he or she telephones the police. The owner must first provide the police with the vehicle identification number, and tell them that a Lo Jack® device is installed. The police may then track the stolen vehicle by locating the device. The stolen automobile is normally located within twenty-four hours. The company that produces this device provides a guarantee that the vehicle will be located within a certain specified time. However, this does not prevent the vehicle from being compromised. Luckily, most vehicles are recovered in good condition, but many are vandalized or destroyed in collisions during a theft.

### DETAILED DESCRIPTION OF THE INVENTION

The Present Invention provides a quicker response with added security. The device of the Present Invention is hidden in the vehicle just like the Lo Jack®. It need not emit any sound. It only transmits an instant message using a working cellular telephone. A handheld touch screen system is optional to enable programming by a user. Another option is password protected remote programming. This latter option would be desirable to enable hiding the Present Invention in the vehicle. The Present Invention is actually a pre-programmed cellular telephone device capable of placing calls over the cellular telephone network. The device auto dials any pre-programmed existing phone numbers. The triggering mechanism alerts the owner in a sequence of warnings. The first warning alerts that door handle is being compromised. The second warning is an alert that the car door has been opened. The third warning alerts that the ignition has started. The fourth warning alerts that the car is in motion. After the fourth warning, the auto dial system prompts the owner to alert the police. The call features are programmed by the owner to be either a simulated voice or text message. The timer delays its response, thereby giving the owner one minute before it sends an alert, which can be canceled. A failure to respond after the delay time causes the device to activate a GPS locator, and informs the police that the vehicle is being stolen. This device can work in conjunction with a Lo Jack® device.

An added feature to the device would be a built-in camera inserted into the lining of the passenger door. The device incorporates a special purpose computer with wireless capability (preferably over the 3G network). The camera takes photo stills when the alarm is triggered during forced entry. The camera would take five sequential photographs that are downloaded into the device of the Present Invention. The photographs are then instantly sent via email to the owner and to the police department.

The advantage of the Present Invention over a Lo Jack® system is that the owner is notified immediately. There is no delay in discovering that the vehicle has been stolen. The device may be used as a stand-alone telephone that notifies the owner. It may have its own GPS locator or it may be used together with a Lo Jack® system. The remote device is wireless and will interface with the Lo Jack® in order to promote optimum security. The Present Invention transmits a real-time instantaneous notification, as compared to the Lo Jack stolen recovery system that must be activated by police once informed by the vehicle owner. There is no delay. The camera is another optional feature.

I claim:

1. A vehicle alarm system comprising:
a) a cellular telephone device capable of automatically dialing calls to pre-programmed telephone numbers wherein said automatic dialing is triggered by desired events in the vehicle; and
b) a triggering mechanism which triggers the automatic dialing based upon said desired events.
